(19) United States
(12) Patent Application Publication
(10) Pub. No.: US 2003/0065671 A1
(43) Pub. Date: Apr. 3, 2003

(54) Method and apparatus for formatting a data grid for the display of a view

(75) Inventor: Robert Raymond Cardenas, Glendale, WI (US)

Correspondence Address: MICHAEL BEST & FRIEDRICH, LLP, 100 E WISCONSIN AVENUE, MILWAUKEE, WI, 53202, US

(73) Assignee: eFunds Corporation, Milwaukee, WI (US)

(21) Appl. No.: 10/226,690

(22) Filed: Aug. 23, 2002

Related U.S. Application Data
(60) Provisional application No. 60/314,484, filed on Aug. 23, 2001.

(51) Int. Cl. G06F 7/00

(52) U.S. Cl. 707/100

(57) ABSTRACT

A method and apparatus for utilizing a single data grid to display one of a plurality of displayable views using a software program or formatter that receives user criteria identifying one of the plurality of displayable views and the data grid a definition. The definition identifies the data set(s) the data grid is to obtain data from, the query used to retrieve the data from the data set(s), and the format used to display the data in the data grid. The definition is included in a set of configuration data associated with one of the plurality of views that is stored in a configuration file. The configuration file is external to the application program that includes the data grid such that the configuration data can be updated without effecting the operation of the application program.

### BACKGROUND OF THE INVENTION

The present invention generally relates to displaying a plurality of views in a data grid, and more particularly, to displaying a plurality of views in a data grid with few, if any, changes to the code of the application program that includes the data grid.

Software programs or applications often include at least one data grid, where each data grid is utilized to display a particular view. Each view includes data from at least one data set organized in a particular format. Generally, each data grid includes a hard coded definition that is predefined within the code of the application. The definition identifies the data set(s) the data grid is to obtain data from, the query used to retrieve the data from the data set(s), and the format used to display the data in the data grid. Thus, a single data grid within an application can only be used to display the single predefined view. If a user desires to display a different view, either another, new data grid needs to be defined within the application, or the definition of the current data grid needs to be altered. Both of these tasks require extensive coding and testing. As a result, accommodating new data sets is very expensive.

### SUMMARY OF THE INVENTION

Accordingly, the invention provides a method and apparatus for utilizing a single data grid to display one of a plurality of displayable views. The invention also provides a software program or formatter that utilizes an externalized set of configuration data to provide the data grid a definition which defines the display of one of a plurality of displayable views.

In one embodiment, the invention gathers user criteria that identifies the view a user desires to observe. The user criteria is utilized by a formatter to select a set of configuration data that includes a definition of the data grid. The formatter provides the definition to the data grid and the definition is utilized to query a data base for data, receive the data, and display the data. The definition includes not only the structure of the query but also the format in which the data is to be displayed. The configuration file that includes the configuration data is external to the application program that includes the data grid such that the configuration data can be updated without effecting the operation of the application program. Further, by externalizing the definition of the data grid, a single data grid can be utilized to display a plurality of views.

As is apparent from the above, it is an advantage of embodiments of the invention to provide a method and system for utilizing a single data grid to display one of a plurality of displayable views where sets of configuration data have been externalized for utilization by a formatter in providing the data grid a definition. Other features and advantages of the invention will become apparent by consideration of the detailed description and accompanying drawings.

### BRIEF DESCRIPTION OF THE DRAWINGS

FIG. 1 is a schematic diagram representing a computer system according to one embodiment of the invention.

FIG. 2 is a diagram defining the architecture of a configuration file used in one embodiment of the invention.

FIG. 3 is a schematic diagram representing a user interface according to one embodiment of the invention.

FIG. 4 is a schematic diagram representing a process implemented using one embodiment of the invention to create a total form.

FIGS. 5 and 5B illustrate an exemplary view generated by one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms “mounted,” “connected,” and “coupled” are used broadly and encompass both direct and indirect mounting, connecting, and coupling. Further, “connected” and “coupled” are not restricted to physical or mechanical connections or couplings.

In some of the examples discussed, terms within quotation marks or capitalized terms are used for convenience and to assist the reader in correlating the description to the drawings. However, these terms should not be considered as having specialized meanings and are meant to be interpreted broadly and generically.

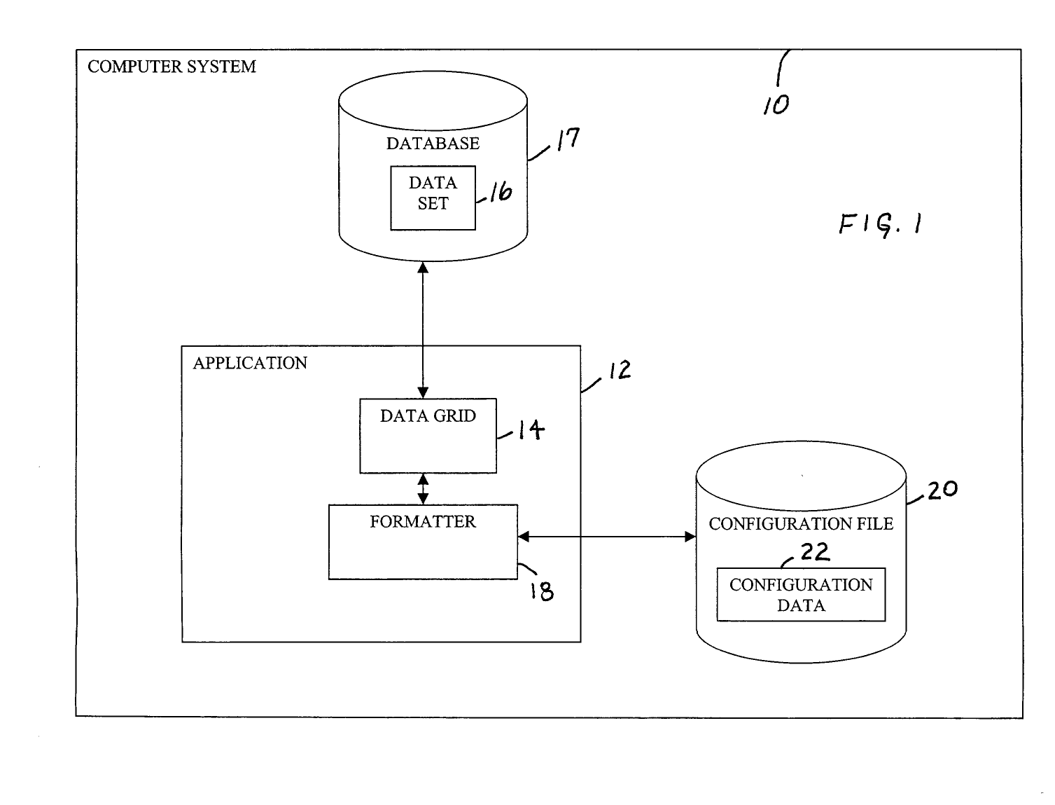

FIG. 1 illustrates an exemplary computer system 10 constructed according to one embodiment of the invention. The computer system 10 includes such well known components as a processor, a memory, input devices (e.g., a keyboard, a pointing device, a mouse, a microphone, etc.), and output devices (e.g., a monitor, speakers, etc.) (all not shown). The computer system 10 is operable to execute or run an application 12. The application 12 includes at least one data grid 14, where each data grid 14 is used to display one of a plurality of displayable views. Each view includes data from at least one data set 16 stored in a database 17. The database 17 may include each data set 16 associated with the application 12, or alternatively, the data sets 16 may be stored in a plurality of databases 17. Each database 17 may be local to or external to the computer system 10.

The computer system 10 also includes a software program or formatter 18 for formatting the data grid 14. The formatter 18 is shown as being part of the application 12. In other embodiments, the formatter 18 may be external to the application or alternately configured. The function of the formatter 18 is transferable over a plurality of applications 12. For example, in one embodiment, the formatter may be implemented as one or more objects, and those objects may be included in a library and utilized through appropriate links and method calls.

The computer system 10 also includes a configuration file 20 that is external to the application 12. The configuration file 20 includes at least one set of configuration data 22 for the data grid 14. In one embodiment, each set of configuration data 22 includes a definition of the data grid 14 for use in displaying a view. Each definition identifies the data set(s) 16 the data grid 14 is to obtain data from, the query used to retrieve the data from the data set(s) 16, and the format used to display the data in the data grid 14.

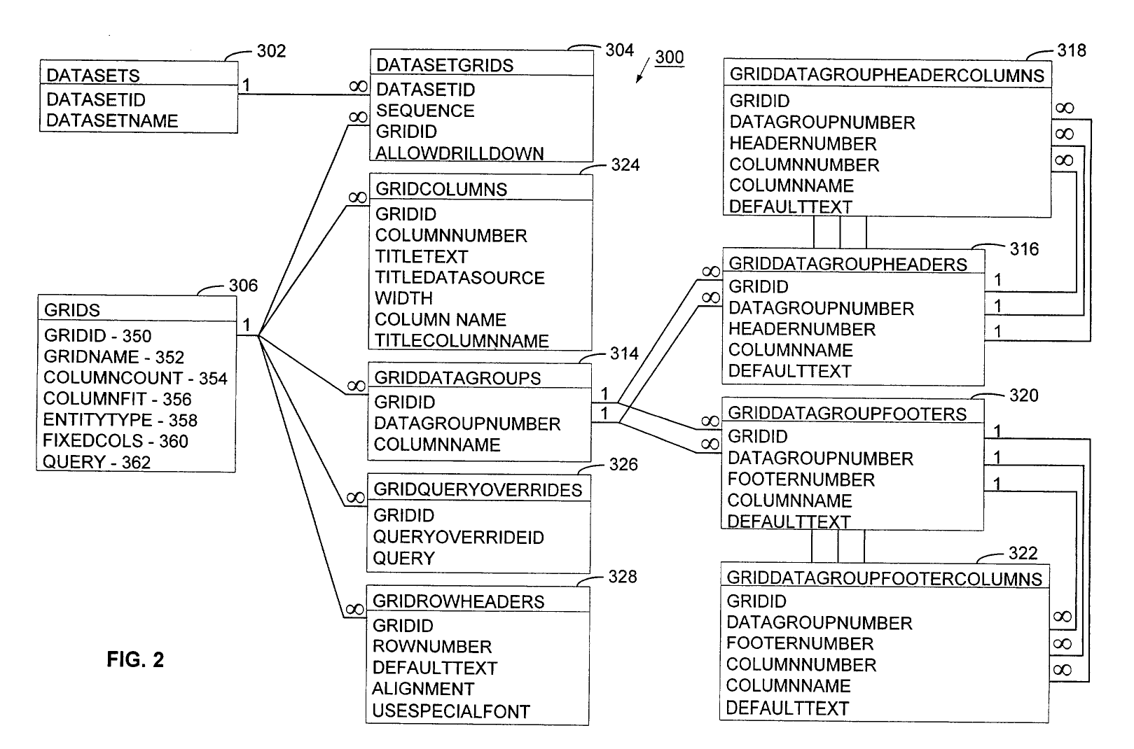

FIG. 2 illustrates a data model 300 that defines the software-based architecture of one embodiment of the configuration file 20. The data model 300 includes a plurality of tables or entities that logically represent the physical storage of each set of the configuration data 22. The tables are relationally linked to, or associated with, one another by a number of links or branches. Cardinality is indicated by the presence of a “one” or an “infinity symbol” on the originating end or the terminating end of the relationship branch. An entity with an “infinity symbol” next to it is the “child” of at least one “parent” entity, and an entity with a “one” next to it is the “parent” of at least one “child” entity. In general, a “parent” entity can have numerous “children.” In other words, if the terminating end of a relationship branch includes an “infinity symbol,” an instance of the originating entity can be related to one or more instances of the terminating entity. If the terminating end of a relationship branch includes a “one,” an instance of the originating entity can be related to only one instance of the terminating entity.

The data model 300 includes a DATASETS table 302, a DATASETGRIDS table 304, a GRIDS table 306, a GRIDCOLUMNS table 308, a GRIDQUERYOVERRIDES table 310, a GRIDROWHEADERS table 312, a GRIDDATAGROUPS table 314, a GRIDDATAGROUPHEADERS table 316, a GRIDDATAGROUPHEADERCOLUMNS table 318, a GRIDDATAGROUPFOOTERS table 320, a GRIDDATAGROUPFOOTERCOLUMNS table 322, a GRIDCOLUMNS table 324, a GRIDQUERYOVERRIDES table 326, and a GRIDROWHEADERS table 328.

Each table in the data model 300 includes a table identifier (ID), at least one data member (e.g., a key or an attribute), and a value (not shown in FIG. 2). In one embodiment, the table ID is representative of the name of the table. A table generally includes a table ID for itself. If a particular table is a “child” table to a “parent” table, the fields section of the table likely also includes a key for that “parent” table. The fields section also typically includes all attributes of the table. Each “parent” table is linked to at least one “child” table. Although data model 300 includes a plurality of “parent” tables, a small data model may only include a single “parent” table. The data model 300 illustrated is only representative and can be expanded to include additional “parent” tables and “child” tables or reduced to include fewer tables.

A description of the GRIDS table 306 is used to illustrate the linking between a “parent” table and “child” tables. The GRIDS table 306 contains the list of all possible sets of configuration data 22 for the data grid 14. The GRIDS table 306 includes a GRIDID 350 which is the table ID. The GRIDS table 306 also includes a number of data members (i.e., attributes) in the fields section, including a GRIDNAME 352,a COLUMNCOUNT 354, a COLUMNFIT 356, a ENTITYTYPE 358, a FIXEDCOLS 360, and a QUERY 362. The GRIDS table 306 has a number of “child” tables including the DATASETGRIDS table 304, the GRIDCOLUMNS table 324, the GRIDDATAGROUPS table 314, the GRIDQUERYOVERRIDES table 326, and the GRIDROWHEADERS table 328. The GRIDDATAGROUPS table 314 is then a “parent” to the GRIDDATAGROUPHEADERS table 316 and the GRIDDATAGROUPFOOTERS table 320. Both of these tables are then “parents” to other representative “child” tables. The string of “family” relationships can continue through a number of “generations”, the number of “generations” being dependent upon how detailed the information represented by the data model is. All “descendent” tables of the GRIDS table 306 also include foreign keys (i.e., table IDs of all the “ascendant” tables to which the “descendent” table is relationally linked) and attributes as indicated in FIG. 2, which, for purposes of brevity, are not discussed further herein.

The DATASETS table 302 contains the list of all possible data sets 16 that can be displayed in the data grid 14 of the application 12. In one embodiment, each type of data set 16 is predetermined and all of the programming and testing related to the display of the corresponding views (e.g., setting up the corresponding configuration data 22) is completed before the application 12 is run. However, if new sets of configuration data 22 are necessary based on the introduction of a new view or a new type of data set 16, the operation of the application 12 does not need to be effected because the configuration file 20 is external to the application. Therefore, new sets of configuration data 22 can be imported into the configuration file 20 without stopping the application 12.

In one embodiment, the formatter 18 can add or delete data sets of configuration data 22 based on use. Storing only the sets of configuration data 22 that are utilized by the formatter 18 reduces memory requirements and makes the overall application 12 run more efficiently.

The DATASETGRIDS table 304 associates the sets of configuration data 22 with the corresponding data sets 16. If the correct correlation is not made, the data is not displayed correctly in the data grid 14 and the user is not able to accurately access the information provided for that view.

The GRIDCOLUMNS table 324 contains the basic column definitions for each defined data grid 14. The basic column definitions include, among other things, the title of the column and the width of the column defined in a standard unit (e.g., pixels).

The GRIDQUERYOVERRIDES table 326 contains additional queries for a data grid 14 that may override the default query defined for the data grid 14 in the GRIDS table 306. The data stored in the data set 16 may be expansive. Only a small percentage of the overall data may be useful to the user of the application 12. The query retrieves the data need for the selected view. The GRIDQUERYOVERRIDES table 326 allows for different queries to be used in accessing and retrieving the data. In one embodiment, additional queries are added while the application 12 is running, where the queries relate to questions the user has which require a further analysis of data.

The GRIDROWHEADERS table 328 defines the text that should be displayed in column zero for specific row entries. In one embodiment, the text displayed for specific row entries can be changed while the application 12 is running.

As discussed above, the configuration data 22 stored external to the application 12 can be altered while the application 12 is running. However, it is generally preferred that a balance between efficient operation of the application 12 and optimal display of a view be struck when implementing an embodiment of the invention. A user interface engine or generator (not shown) can be incorporated into the application 12 that creates a user interface that allows the user to quickly request alteration of the view. The formatter 18 can then adjust the configuration data 22 currently defined in the configuration file 20 for that particular view. If the requested changes are too complex, the configuration data 22 defined in the configuration file 20 may need to be altered offline. In general, such alteration is still much faster than recoding and retesting the application.

For the sake of brevity, the functions of the remaining tables are summarily noted. The GRIDDATAGROUPS table 314 defines data groups for the data grid 14 based on a common column. The GRIDDATAGROUPHEADERS table 316 defines header lines that are displayed for a particular data group. The GRIDDATAGROUPHEADERCOLUMNS table 318 defines properties for each column of a header line. The GRIDDATAGROUPFOOTERS table 320 defines footer lines that are displayed for a data group. The GRIDDATAGROUPFOOTERCOLUMNS table 322 defines properties for each column of a footer line.

Following is a table that further explains many of the data members included in the data model 300.

| Data Member | Values | Notes |
|---|---|---|
| ALIGNMENT | CENTER | Defines how text is to be |
| | LEFT | aligned within the cells of |
| | RIGHT | the column. The value can |
| | JUSTIFY | be set to any standard align- |
| | | ment mode. |
| ALLOWDRILLDOWN | YES | A YES/NO indicator that |
| | NO | either allows or disallows |
| | | the ability to “drill down” |
| | | from one data grid to an- |
| | | other. The process of |
| | | drilling down is typically |
| | | used when one data grid |
| | | shows summary informa- |
| | | tion for multiple items. If |
| | | drill down is allowed, |
| | | the user can then select an |
| | | item in the data grid and |
| | | open a new data grid that |
| | | displays the detail for that |
| | | item. |
| COLUMNCOUNT | | This identifies the number |
| | | of columns in the data grid. |
| COLUMNFIT | CONTENTS | Identifies column auto- |
| | WINDOW | sizing characteristics. If |
| | FIXED | CONTENTS, then each |
| | | column is sized to fit |
| | | the contents of each cell. |
| | | This may leave white space |
| | | between the last col- |
| | | umn and the right edge of |
| | | the grid. If WINDOW, |
| | | then each column is sized |
| | | to fit the contents of each |
| | | cell. Any remaining white |
| | | space that exists between |
| | | the last column and |
| | | the right edge of the data |
| | | grid is distributed evenly |
| | | amongst the columns. If |
| | | FIXED, then each column |
| | | is sized according to its |
| | | COLnWIDTH property. |
| COLUMNNAME | | Identifies a column returned |
| | | by a query. |
| COLUMNNUMBER | | Identifies a specific column |
| | | of a data grid. The first col- |
| | | umn of a data grid is identi- |
| | | fied as column zero (0), and |
| | | subsequent columns of |
| | | the data grid are sequen- |
| | | tially numbered (i.e., zero |
| | | based). |
| DATAGROUPNUMBER | | A sequence number that |
| | | uniquely identifies one data |
| | | group from another data |
| | | group within a particular |
| | | data grid. |
| DATASETID | | An ID that uniquely identi- |
| | | fies one data set from an- |
| | | other. |
| DATASETNAME | | A long name for a data set. |
| DEFAULTTEXT | | The default text to be dis- |
| | | played when no other value |
| | | is available. The default |
| | | text displayed depends |
| | | upon what type of informa- |
| | | tion is displayed in the data |
| | | grid (e.g., “NA”, “blank”, |
| | | “0”, etc.) |
| ENTITYTYPE | | Defines the type of entity |
| | | that is always displayed |
| | | within this data grid. May |
| | | be any of the valid entity |
| | | types (e.g., for a “totals” |
| | | data grid, the valid entity |
| | | types may include a |
| | | switch, a processor, an |
| | | institution, a device, a |
| | | courier, a courier route, |
| | | etc). |
| FIXEDCOLS | | Defines the number of col- |
| | | umns that are used as row |
| | | headers. These columns |
| | | remain fixed on the data |
| | | grid as the user is scrolling |
| | | through the other columns. |
| FOOTERNUMBER | | A sequence number that |
| | | uniquely identifies one |
| | | footer line from another |
| | | footer line within a par- |
| | | ticular data grid data group. |
| GRIDID | | An ID that uniquely |
| | | identifies one data grid |
| | | from another data grid. |
| GRIDNAME | | A long name for a data |
| | | grid. |
| HEADERNUMBER | | A sequence number that |
| | | uniquely identifies one |
| | | header line from another |
| | | header line within a particu- |
| | | lar data grid data group. |
| QUERY | | Defines the WHERE |
| | | clause and ORDER BY |
| | | clause of the structured |
| | | query language (SQL) |
| | | query used to load this |
| | | grid with data. |
| QUERYOVERRIDEID | | An ID that uniquely iden- |
| | | tifies one query override |
| | | from another query over- |
| | | ride. |
| SEQUENCE | | A number used to uniquely |
| | | identify items. |
| TITLECOLUMNNAME | | Identifies the column whose |
| | | value should be used as |
| | | the title for another col- |
| | | umn in the data grid. |
| | | The name specified here |
| | | must exist in the data |
| | | source identified in |
| | | the TitleDataSource. |
| TITLETEXT | | The default caption that |
| | | is to be displayed for a |
| | | particular column. |
| TITLEDATASOURCE | VIEWOBJECT | Allows dynamic override of |
| | QUERY | the default column title. |
| | | Valid values for |
| | | TITLEDATASOURCE |
| | | are VIEWOBJECT and |
| | | QUERY. |
| USESPECIALFONT | YES | A YES/NO flag that trig- |
| | NO | gers the application of |
| | | the standard font used |
| | | for header cells. The stand- |
| | | ard font for header cells |
| | | may be hard coded within |
| | | the application. |
| WIDTH | | The minimum width of a |
| | | column specified in pixels. |

The data model 300 is a generalized data model. The data model can be altered based on the type of application 12 in which the data grid 14 resides.

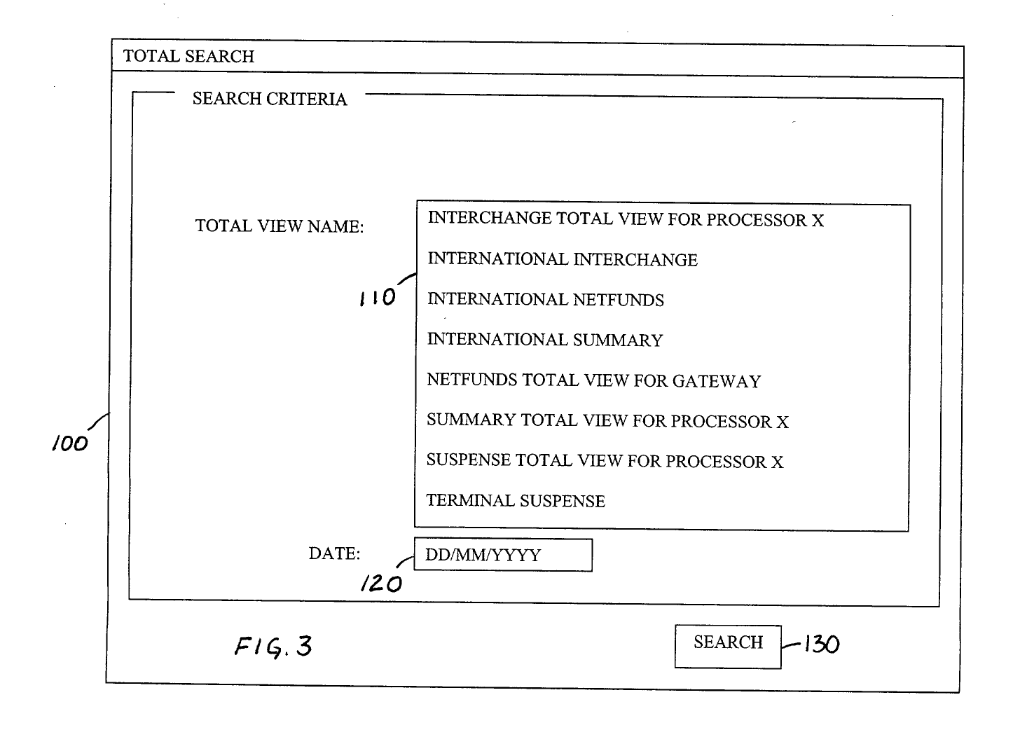

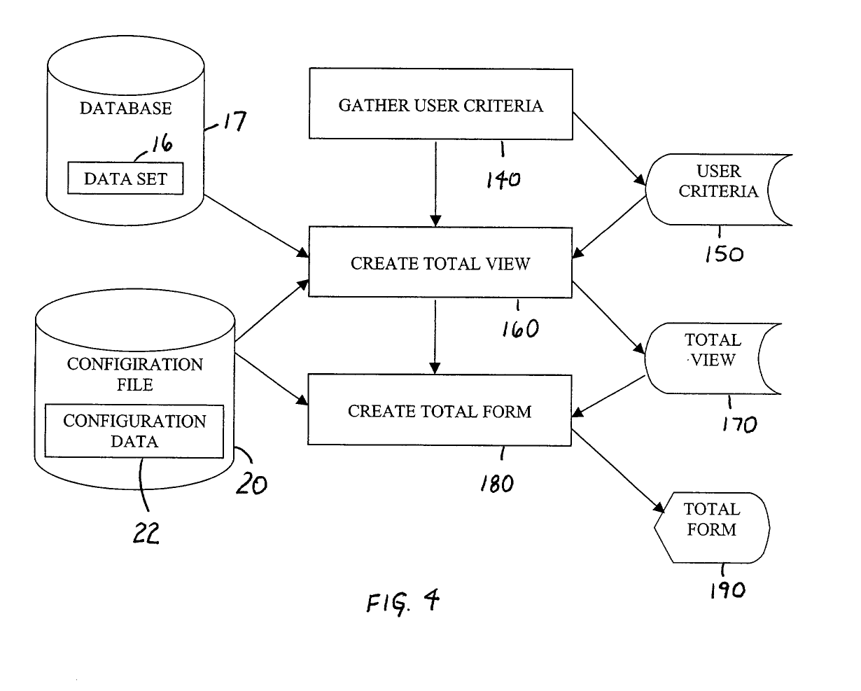

In one embodiment, the application 12 is utilized to provide “totals” information to the user. The views associated with the application 12 provide the user different types and formats of “totals” data. In order for the user to access a particular view, a user interface such as the search screen 100 shown in FIG. 3 is utilized. The search screen 100 allows the user to input user criteria such as a total view name 110 (e.g., INTERCHANGE TOTAL VIEW FOR PROCESSOR X, INTERNATIONAL INTERCHANGE, INTERNATIONAL NETFUNDS, INTERNATIONAL SUMMARY, NETFUNDS TOTAL VIEW FOR GATEWAY, SUMMARY TOTAL VIEW FOR PROCESSOR X, SUSPENSE TOTAL VIEW FOR PROCESSOR X, TERMINAL SUSPENSE, etc.) and a date 120. Other embodiments may include other types of user criteria. Once the user has defined the user criteria, the search button 130 is selected.

As shown in FIG. 4, the user criteria is gathered at step 140 and stored in memory 150. At step 160, the user criteria is utilized by the formatter 18 to select a set of configuration data 22 from the configuration file 20, where the selected set of configuration data 22 corresponds to the selected view. The formatter 18 provides the data grid 14 a definition using the selected configuration data 22. The data grid 14 utilizes the definition to locate the appropriate data set(s) 16, query the data set(s), and display the results of the query in the data grid 14 to create a total view. The total view is stored in memory 170. At step 180, the total view and additional configuration data 22 are utilized to create a total form which is displayed using display 190. The total form may include a single view or a plurality of views. Generally, each view includes a single data grid 14.

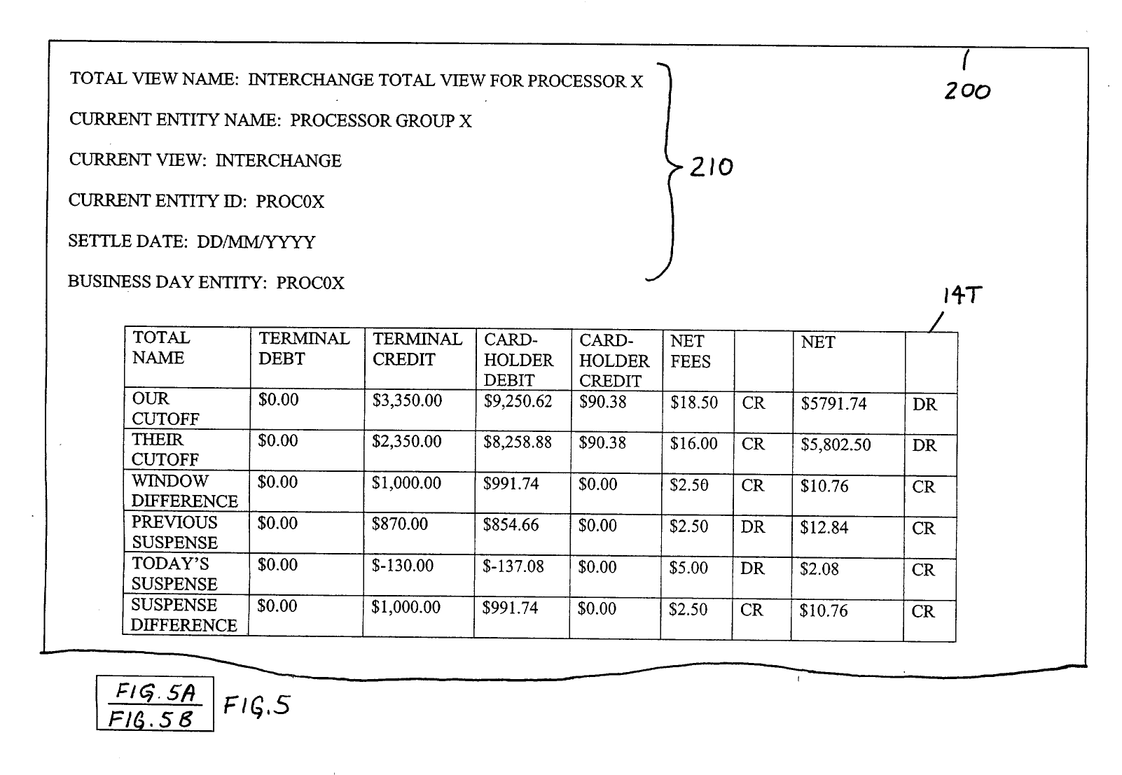

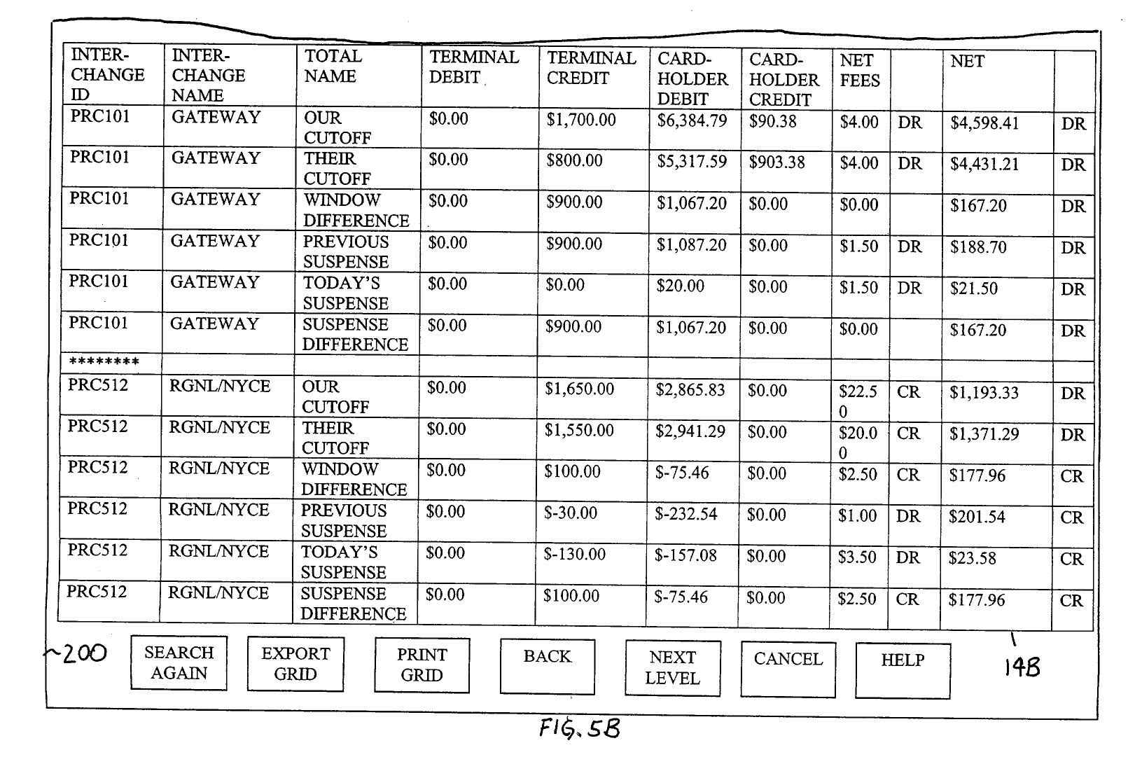

The totals form 200 illustrated in FIG. 5 (FIGS. 5A and 5B) includes two views and thus a top data grid 14T and a bottom data grid 14B. The totals form 200 further includes header information 210 which provides the user information about the form and the views it includes (e.g., the name of the view, the entity name, the current view, the entity ID, the settle date, and the business day entity, etc.).

In one embodiment, a TOTALGROUP table within the configuration file 20 defines all of the possible total types, or data sets, (e.g., INTERCHANGE TOTAL VIEW FOR PROCESSOR X, INTERNATIONAL INTERCHANGE, INTERNATIONAL NETFUNDS, INTERNATIONAL SUMMARY, NETFUNDS TOTAL VIEW FOR GATEWAY, SUMMARY TOTAL VIEW FOR PROCESSOR X, SUSPENSE TOTAL VIEW FOR PROCESSOR X, TERMINAL SUSPENSE, etc.) for the “totals” application 12. Following is a table that includes entries that are defined for each total type. Note that only the first 9 characters of the total type are used when formatting the table name. The name of the table is generically shown as TOTALTYPE.

| Table | Key | Value | Notes |
|---|---|---|---|
| *TOTALTYPE | ALLOWDRILLDOWN | YES | Optional. See |
| | | NO | description above. |
| *TOTALTYPE | SUMMARYCONFIGTABLEKEY | | Optional. If this entry |
| | | | does not exist for the |
| | | | total type, the table name |
| | | | defaults to the following |
| | | | format: *[first |
| | | | 3 characters of the total |
| | | | type][BOTTOM]GRID. |
| | | | For example, the table |
| | | | name for the ACME |
| | | | summary data grid is |
| | | | *ACMBOTTOMGRID. |
| *TOTALTYPE | DETAILCONFIGTABLEKEY | | Optional. If this entry |
| | | | does not exist for the |
| | | | total type, the table name |
| | | | defaults to the following |
| | | | format: *[first |
| | | | 3 characters of the total |
| | | | type][TOP]GRID. For |
| | | | example, the table name |
| | | | for the ACME detail |
| | | | grid is |
| | | | *ACMTOPGRID |

Following is a table that includes entries that are included in the set of configuration data 22 as part of the definition for each “totals” data grid 14. The name of the data set 16 associated with the definition is equal to the predefined value for either SUMMARYCONFIGTABLEKEY or DETAILCONFIGTABLEKEY.

| Key | Value | Notes |
|---|---|---|
| COLUMNCOUNT | | This identifies the number of |
| | | columns in the data grid |
| COLUMNFIT | CONTENTS | Optional. Identifies column auto- |
| | WINDOW | sizing characteristics. If |
| | FIXED | CONTENTS, then each column is |
| | | sized to fit the contents of each cell. |
| | | This may leave white space between |
| | | the last column and the right edge of |
| | | the grid. If WINDOW, then each |
| | | column is sized to fit the contents of |
| | | each cell. Any remaining white |
| | | space that exists between the last |
| | | column and the right edge of the grid |
| | | is distributed evenly amongst the |
| | | columns. If FIXED, then each |
| | | column is sized according to its |
| | | COLnWIDTH property. |
| COLnTITLE | | Required. Zero based. |
| COLnTITLEOVERRIDE | DATASOURCE = | Optional. Zero based. Allows |
| | VIEWOBJECT | dynamic override of the default |
| | QUERY | column title. Valid values for |
| | FIELD = | DataSource are VIEWOBJECT and |
| | | QUERY. If Datasource = |
| | | VIEWOBJECT and Field = |
| | | SUMMARYENTITYIDLABEL, |
| | | then the value of the summary |
| | | entity's label is used. The summary |
| | | entity's label is calculated by the |
| | | view object based on the type of |
| | | entity displayed in the summary grid. |
| | | For example, if the summary grid |
| | | currently contains a list of |
| | | institutions, then the |
| | | SUMMARYENTITYIDLABEL is |
| | | equal to “Institution ID”. |
| COLnWIDTH | | Required if COLUMNFIT is equal to |
| | | FIXED. |
| COL0ROWnHDR | | Optional. Defines additional row |
| | | headings that are to be displayed in |
| | | column 0. |
| COL0ROWnPROPERTIES | ALIGNMENT = | Optional. ALIGNMENT defines |
| | CENTER | how text is to be aligned within the |
| | USESPECIALFONT = | cells of the column. Only the value |
| | YES | CENTER is supported. |
| | NO | USESPECIALFONT is a YES/NO |
| | | flag that triggers the application of |
| | | the standard font used for header |
| | | cells. The standard font for header |
| | | cells is currently hard coded within |
| | | the application. |
| COLnFIELD | | Required. |
| ENTITY_TYPE | | Optional. Defines the type of entity |
| | | that is always displayed within this |
| | | data grid. May be any of the valid |
| | | entity types. |
| FIXEDCOLS | | Optional. Defines the number of |
| | | columns that are used as row headers. |
| | | These columns remain fixed on the |
| | | data grid as the user is scrolling |
| | | through the other columns. |
| QUERY | | Optional. Defines the WHERE |
| | | clause and ORDER BY clause of the |
| | | SQL query used to load this data grid |
| | | with data. |
| QUERYcolumn | | Optional. Defines the WHERE |
| | | clause and ORDER BY clause of the |
| | | SQL query used to load this grid with |
| | | data. This entry overrides the |
| | | standard QUERY attribute when the |
| | | grid is being loaded with data for a |
| | | particular entity type. |
| ROWBRKnCOLUMN | | Optional. Identifies a column of the |
| | | data grid that will be used to define a |
| | | logical grouping of the data within |
| | | the data grid. When the value of this |
| | | column changes, a “row break” is |
| | | inserted. Header lines appear before a |
| | | group of data. Separator lines |
| | | appear after a data group. |
| ROWBRKnSEPn | FIELD = | Optional. Defines attributes for one |
| | DEFAULT = | of the separator lines of the row |
| | | break. Since most row breaks only |
| | | define a value for the first column, |
| | | the FIELD and DEFAULT attributes |
| | | have been added here as convenience. |
| | | These settings will be used as the |
| | | value for the first column of the row |
| | | break separator line. The same |
| | | values could also have been defined |
| | | with the ROWBRKnSEPnCOLn. |
| | | See ROWBRKnSEPnCOLn for |
| | | definition of FIELD and DEFAULT. |
| ROWBRKnSEPnCOLn | FIELD = | Optional. Defines the value to be |
| | DEFAULT = | displayed in the identified column of |
| | | this separator line. FIELD identifies a |
| | | column of the supporting query |
| | | whose value should be displayed |
| | | here. DEFAULT identifies a string |
| | | literal that should be displayed if the |
| | | FIELD attribute has not been defined OR |
| | | the column identified in the |
| | | FIELD attribute does not exist in the |
| | | supporting query. |
| ROWBRKnHDRn | FIELD = | Optional. Defines attributes for one |
| | DEFAULT = | of the header lines of the row break. |
| | | Since most row breaks only define a |
| | | value for the first column, the FIELD and |
| | | DEFAULT attributes have been |
| | | added here as convenience. These |
| | | settings will be used as the value for |
| | | the first column of the row break |
| | | header line. The same values could |
| | | also have been defined with the |
| | | ROWBRKnHDRnCOLn. Currently |
| | | we do not define any other attributes |
| | | for the header lines, but we may add |
| | | some in the future. See |
| | | ROWBRKnHDRnCOLn for |
| | | definition of FIELD and DEFAULT. |
| ROWBRKnHDRnCOLn | FIELD = | Optional. Defines the value to be |
| | DEFAULT = | displayed in the identified column of |
| | | this header line. DEFAULT |
| | | identifies a string literal that should |
| | | be displayed if the FIELD attribute |
| | | has not been defined OR the column |
| | | identified in the FIELD attribute does |
| | | not exist in the supporting query. |

Thus, as can be seen from the above, the invention provides, among other things, a method and system for utilizing a single data grid to display one of a plurality of displayable views where sets of configuration data have been externalized for utilization by a formatter in providing the data grid a definition.

1. A system for displaying a view, the system comprising:
an application program having a data grid, the application program operable to display a plurality of views using the data grid;
a configuration file that stores a plurality of sets of configuration data for the data grid, wherein the configuration file is external to the application program;
a formatter operable to receive user criteria identifying one of the plurality of views, and to provide the data grid a definition based on the user criteria using one of the plurality of sets of configuration data;
wherein the data grid is operable, using the definition, to receive data associated with the user criteria identified view from at least one data set, and to display the data.

2. The system of claim 1, wherein each view is associated with one set of configuration data.

3. The system of claim 1, wherein each view is associated with at least one data set.

4. The system of claim 1, wherein the user criteria includes a date.

5. The system of claim 1, wherein the user criteria includes a view name.

6. The system of claim 1, wherein at least one view displays totals data.

7. The system of claim 1, wherein the definition includes a value corresponding to the alignment of data within a cell of the data grid.

8. The system of claim 1, wherein the definition includes a value corresponding to the ability to drilldown from the data grid to another data grid of the system.

9. The system of claim 1, wherein the definition includes a value corresponding to the number of columns in the data grid.

10. The system of claim 1, wherein the definition includes a value corresponding to default text displayed in a cell of the data grid when no data exists for the cell.

11. The system of claim 1, wherein the definition includes a value corresponding to a query utilized to search for the data received by the data grid.

12. The system of claim 1, wherein the definition includes a value corresponding to a query override.

13. The system of claim 1, wherein the application program includes the formatter.

14. The system of claim 1, wherein the formatter is external to the application program.

15. A method of utilizing a data grid to display one of a plurality of displayable views, the method comprising:
providing an application program having a data grid;
providing a configuration file having at least one set of configuration data, wherein the configuration file is external to the application program;
providing a database having at least one data set;
providing a formatter operable to receive user criteria associated with the one view, to select a set of configuration data based on the user criteria, and to provide the data grid a definition using the selected set of configuration data;
using the definition to query the database for data; and
displaying the data in the data grid using the definition.

16. The method of claim 15, wherein each displayable view is associated with one set of configuration data.

17. The method of claim 15, wherein each displayable view is associated with at least one data set.

18. The method of claim 15, wherein the user criteria includes a date.

19. The method of claim 15, wherein the user criteria includes a view name.

20. The method of claim 15, wherein at least one of the displayable view displays totals data.

21. The method of claim 15, wherein the definition includes a value corresponding to the alignment of data within a cell of the data grid.

22. The method of claim 15, wherein the definition includes a value corresponding to the ability to drilldown from the data grid to another data grid of the system.

23. The method of claim 15, wherein the definition includes a value corresponding to the number of columns in the data grid.

24. The method of claim 15, wherein the definition includes a value corresponding to the default text displayed in a cell of the data grid when no data exists for the cell.

25. The method of claim 15, wherein the definition includes a value corresponding to a query utilized to search for the data received by the data grid.

25. The method of claim 15, wherein the definition includes a value corresponding to a query override.

26. The method of claim 15, wherein the application program includes the formatter.

27. The method of claim 15, wherein the formatter is external to the application program.

28. A method of formatting a data grid, the method comprising:
providing an application program having a data grid;
externalizing at least one definition of the data grid;
providing one definition to the data grid based on user criteria; and
using the definition to obtain and display data in the data grid.
